(19) United States
(12) Patent Application Publication
(10) Pub. No.: US 2026/0155570 A1
(43) Pub. Date: Jun. 4, 2026

(54) ANTENNA DEVICE AND METHOD OF FORMING THE SAME

(71) Applicant: TRON FUTURE TECH INC., HSINCHU CITY (TW)

(72) Inventors: KUAN-NENG CHEN, HSINCHU CITY (TW); HAN-WEN HU, HSINCHU CITY (TW); DAO-MING WU, HSINCHU CITY (TW)

(21) Appl. No.: 19/310,719

(22) Filed: Aug. 26, 2025

Related U.S. Application Data
(60) Provisional application No. 63/726,718, filed on Dec. 2, 2024.
(60) Provisional application No. 63/726,727, filed on Dec. 2, 2024.

(51) Int. Cl. H01Q 9/04; C03C 17/36; H01Q 1/12; H01Q 1/28; H01Q 1/48

(52) U.S. Cl. CPC H01Q 9/0414; C03C 17/3626; C03C 17/3649; H01Q 1/1271; H01Q 1/48; C03C 2217/213; C03C 2217/253; C03C 2217/258; C03C 2217/281; C03C 2218/115; C03C 2218/154; H01Q 1/288

(57) ABSTRACT

A method of forming an antenna device includes: receiving a substrate formed of glass; and forming a redistribution layer (RDL) over the substrate. The formation of the RDL includes: depositing a first metallization layer over a first surface of the substrate; depositing a first patterned dielectric layer over the first metallization layer, wherein the first patterned dielectric layer has a first thickness; depositing a second metallization layer over the first patterned dielectric layer; and forming a second patterned dielectric layer over the second metallization layer. The second dielectric layer comprises a photoimageable dielectric (PID) material. The second patterned dielectric layer has a second thickness at least twice the first thickness.

### PRIORITY CLAIM AND CROSS-REFERENCE

This application claims priority to U.S. provisional applications Ser. No. 63/726,718 and 63/726,727, both filed Dec. 2, 2024, the disclosures of both of which are hereby incorporated by reference in their entirety.

### BACKGROUND

In modern wireless communication technologies, satellite communications have attracted significant attention due to advantages such as improved signal coverage and greater bandwidth compared to those of conventional terrestrial communication technologies. Incorporating satellite communication systems into existing cellular terrestrial networks appears promising for enhancing both the coverage and the bandwidth of current wireless communication infrastructures. Furthermore, phased array antenna technology is commonly employed in satellite communications to improve power efficiency over relatively long transmission distances. However, current electronic and semiconductor manufacturing techniques suitable for lower frequency bands are inadequate for providing cost-effective, high-performance solutions for forming phased array antennas operating in high-frequency bands for satellite communications. Consequently, market adoption of satellite communication-based products has been slow. Therefore, there is a need to develop a novel manufacturing process for producing low-cost, high-performance phased array antennas.

### SUMMARY

According to embodiments of the present disclosure, a method of forming an antenna device includes: receiving a substrate formed of glass; and forming a redistribution layer (RDL) over the substrate. The forming of the RDL includes:
depositing a first metallization layer over a first surface of the substrate; depositing a first patterned dielectric layer over the first metallization layer, wherein the first patterned dielectric layer has a first thickness; depositing a second metallization layer over the first patterned dielectric layer; and forming a second patterned dielectric layer over the second metallization layer. The second dielectric layer comprises a photoimageable dielectric (PID) material. The second patterned dielectric layer has a second thickness at least twice the first thickness.

According to embodiments of the present disclosure, an antenna device includes: a substrate formed of glass; and a redistribution layer (RDL) arranged on a first surface of the substrate. The RDL includes: a first metallization layer over the first surface of the substrate; a first dielectric layer over the first metallization layer, wherein the first dielectric layer has a first thickness; a second metallization layer over the first dielectric layer and electrically coupled to the first metallization layer; and a second dielectric layer over the second metallization layer and the first dielectric layer. The second dielectric layer comprises a photoimageable dielectric (PID) material, wherein the second dielectric layer has a thickness at least twice the first thickness.

Through the arrangement of the proposed antenna device, the redistribution layer (RDL) of the antenna device can be formed with a thickness that corresponds to an operating frequency of the antenna device in a cost-effective manner. The performance of the antenna device can also be maintained or improved.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a perspective view of a phased array antenna, in accordance with some embodiments of the present disclosure.

FIG. 1B is a cross-sectional view of the phased array antenna shown in FIG. 1A, in accordance with some embodiments of the present disclosure.

FIGS. 2A, 2B, 2C, 2D, 2E, 2F, 2G, 2H, 2I, 2J, 2K, 2L, 2M, 2N, 2O, 2P and 2Q are cross-sectional views of intermediate stages of a method of forming a phased array antenna, in accordance with some embodiments of the present disclosure.

FIGS. 3A, 3B, 3C, 3D, 3E, 3F, 3G, 3H and 3I are cross-sectional views of intermediate stages of a method of forming a phased array antenna, in accordance with some embodiments of the present disclosure.

FIG. 4A is a cross-sectional view of a phased array antenna, in accordance with some embodiments of the present disclosure.

FIG. 4B is an overlaid top view of conductive vias in different metallization layers, in accordance with some embodiments of the present disclosure.

FIG. 5 is a cross-sectional view of an antenna device, in accordance with some comparative embodiments.

FIG. 6 is a schematic flowchart of a method of forming an antenna device, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features are not in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “about,” “approximate,” “approximately,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

As used herein, the term “connected” may be construed as “electrically connected,” and the term “coupled” may also be construed as “electrically coupled.” “Connected” and “coupled” may also be used to indicate that two or more elements cooperate or interact with each other.

Embodiments of the present disclosure include an antenna device, e.g., a phased array antenna, designed for terrestrial and/or non-terrestrial wireless communications. A structure of the phased array antenna includes an array of antenna units and an array of radio-frequency (RF) chips on two sides of a substrate. According to some embodiments, the substrate is a glass-based substrate with high planarity, low loss and low cost, and is therefore more suitable for a large-scale phased array antenna than other low-loss materials, such as ceramics. Additionally, one or more slits or slots are formed in an antenna ground plane for magnetoelectrically coupling an RF signal between an antenna patch of the phased array antenna and the slits. According to some embodiments, a region of the glass-based substrate between the antenna patch and the slits is substantially free of conductive elements, thereby saving the cost of forming a through-glass via (TGV) that carries the RF signal in the substrate. Further, the antenna device includes a redistribution layer (RDL) serving as a circuit layer for accommodating signal lines and ground planes over the substrate. When the RDL is incorporated into an RF circuit along with the TGV-free glass-based substrate for operation with high-frequency RF signals, e.g., RF signals of 10 gigahertz (GHz) or above, the thickness of the RDL should be specifically determined to correspond to a wavelength of the operating frequency of the RF signal. However, currently available cost-effective film technologies for forming the RDL in other applications are not suitable for forming the RDL used in the TGV-free glass substrate with the determined RDL thickness. In view of the above, a novel and cost-effective method for forming the RDL with the determined thickness is proposed in the present disclosure. As a result, a high-performance phased array antenna can be achieved with relatively low manufacturing cost.

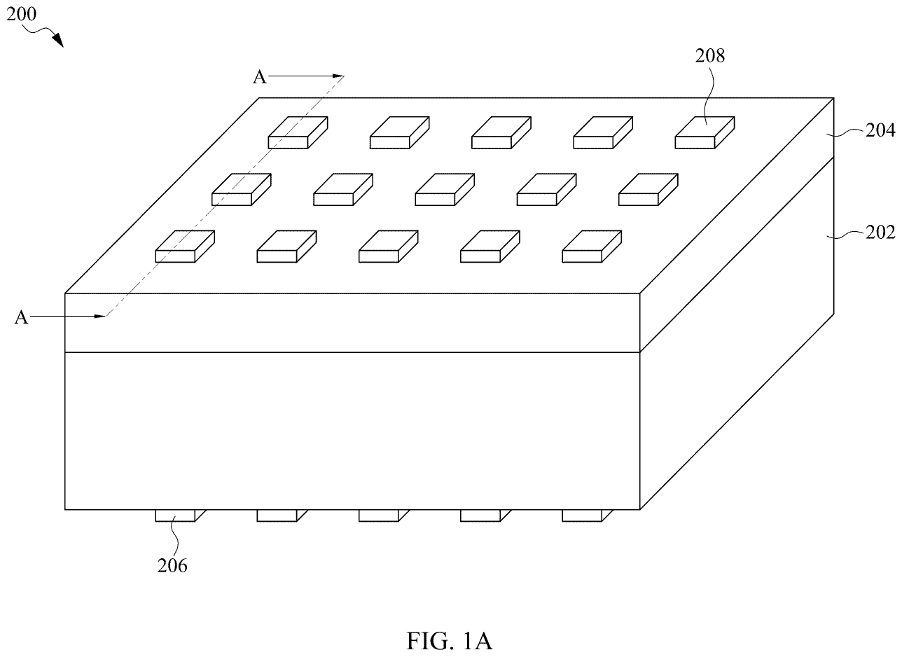

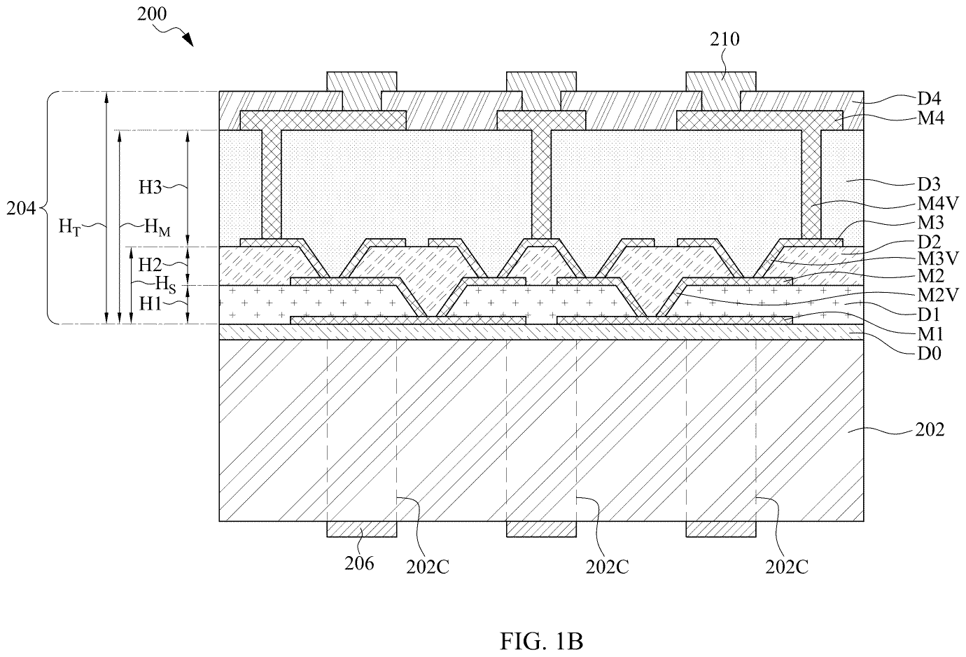

FIG. 1A is a perspective view of a phased array antenna 200, in accordance with some embodiments of the present disclosure. FIG. 1B is a cross-sectional view of the phased array antenna 200 shown in FIG. 1A, in accordance with some embodiments. The cross-sectional view is taken along a sectional line AA of FIG. 1A. According to some embodiments, the phased array antenna 200 is an RF transmitter configured to transmit an RF signal, or an RF receiver configured to receive an RF signal. The phased array antenna 200 includes an array of antenna units, wherein dimensions of the array are determined based on requirements, and a 3×5 array of the phased array antenna 200 is shown for illustrative purposes only. Other array configurations of the phased array antenna 200 are also within the contemplated scope of the present disclosure. The phased array antenna 200 includes a substrate 202, an RDL 204, an array of antenna patches 206 and an array of RF chips 208. The number of the antenna patches 206 may be same as a number of the RF chips 208.

The RDL 204 has an upper surface, and the substrate 202 has a lower surface on a side of the substrate 202 opposite to the RDL 204. The array of antenna patches 206 are formed on the lower surface of the substrate 202, while the array of RF chips 208 are arranged over the upper surface of the RDL 204. Each of the RF chips 208 may include one or more semiconductor dies configured to generate, transmit, receive, or process RF signals. The RF signals may be operated at a frequency in a range between tens of kilohertz (KHz), e.g., 10 kHz, and hundreds of gigahertz (GHz), e.g., 300 GHz, such as about 30 GHz operated in satellite communications. According to some embodiments, the antenna patches 206 are configured to emit RF signals received from the RF chip 208 and radiate the RF signals outwardly, or to receive RF signals from an external source and transmit the RF signals to the RF chip 208. The antenna patches 206 may be formed of conductive materials, such as copper, and may have a circular or elliptical shape. According to some embodiments, the antenna patches 206 may have a thickness between about 10 micrometers (μm) and about 100 μm.

According to some embodiments, the substrate 202 is formed of a transparent material, such as glass, fused silica, silicon oxide, quartz, or the like. According to some embodiments, the substrate 202 separates the antenna patches 206 from the RDL 204 and the RF chips 208. The RF signals may be transmitted from the RF chip 208, through the RDL 204 and a signal channel 202C in the substrate 202, and toward the antenna patches 206. A thickness of the substrate 202 may be between about 0.5 millimeters (mm) and about 1.5 mm. The signal channel 202C may be formed of the transparent material of the substrate 202. Since the material of the substrate 202 is transparent to the RF signals, the substrate 202 itself can serve as the material of the signal channel 202C and is free of any additional conductive members, e.g., TGVs, within a projection area of the antenna patch 206, such that the signal channel 202C is operable to electromagnetically transmit the RF signal between the RDL 204 and the antenna patches 206. Such TGV-free substrate 202 is advantageous in reducing manufacturing cost and time.

According to some embodiments, a key design parameter of the phased array antenna 200 is the thickness of the RDL 204. In contrast to other low-frequency applications, the circuit design for RF circuits or antennas requires the thickness of the RDL 204 to be within a specific range not only for reducing the size of the antenna package, but also for the rule stipulating that the thickness of the RDL 204 correspond to one half of the wavelength of the RF signal so as to optimize a performance of the RF signal. Further, the manufacturing cost of the proposed phased array antenna 200 can be reduced via use of cost-effective techniques to form the RDL 204.

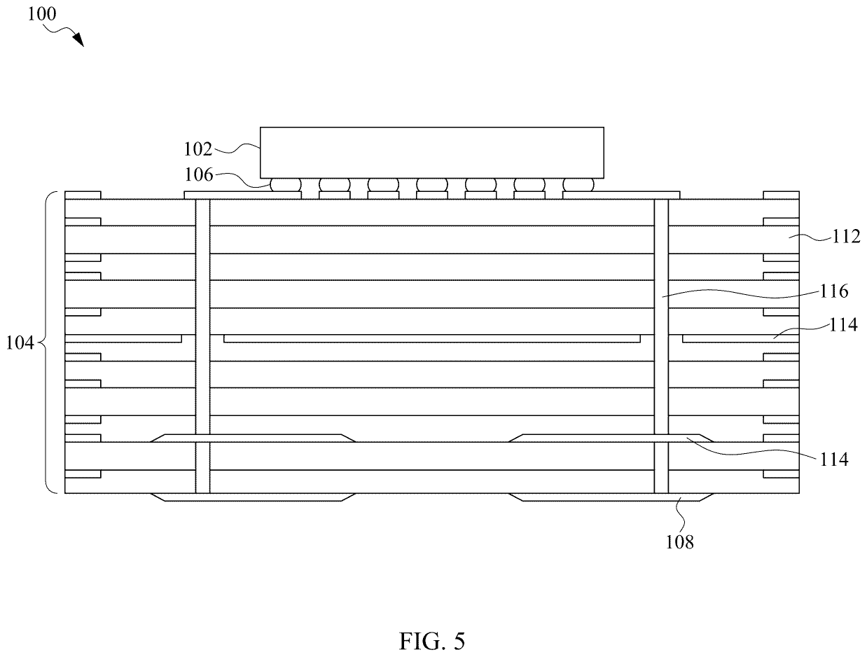

An existing cost-effective RDL technique adopts a printed circuit board (PCB) as an RDL substrate, as shown in FIG. 5. FIG. 5 is a cross-sectional view of an antenna device 100, in accordance with some comparative embodiments. According to such comparative embodiments, the antenna device 100 is an antenna unit of a phased array antenna. The antenna device 100 may include an RF chip 102, an RDL 104, a plurality of conductive bumps 106, and one or more antenna patches 108. The RF chip 102 and the antenna patch 108 may be similar to the RF chip 208 and the antenna patch 206, respectively, and descriptions of similar features are omitted for brevity.

With the PCB used as the RDL substrate, the RDL 104 may include a plurality of dielectric layers 112, one or more conductive lines or pads 114, and a plurality of conductive vias 116. The dielectric layers 112 may be formed of FR-4 (a fiberglass epoxy laminate), prepreg (resin-soaked glass cloth), epoxy, or another suitable dielectric material. The conductive lines or pads 114 may be patterned to form signal lines or ground planes extending in a horizontal direction for transmission or reception of RF signals. Similarly, the conductive vias 116 are arranged to form conductive paths in a vertical direction for transmission or reception of the RF signals. The conductive lines/pads 114 and the conductive vias 116 may be further interconnected to electrically transmit the RF signals between the RF chip 102 and the antenna patches 108 through the RDL 104 and the conductive bumps 106.

According to some comparative embodiments, the thickness of a common single-layer FR-4 dielectric layer 112 is between about 0.8 mm and about 3.2 mm. Although use of FR-4 or other similar epoxy-based materials for forming the PCB as the substrate of the RDL 104 is a proven approach and provides cost advantages, the use of such materials may not be suitable for high-frequency applications, especially those in which the RF signals operate at frequencies used in satellite communications, e.g., 30 GHz or above. That is because key dimensions of the antenna device 100 or the phased array antenna 200, e.g., a width and spacing of the conductive line 114 or a total thickness of the RDL 104 or 204, are determined to be decreased when the frequency of the RF signal is increased (or, equivalently, when a wavelength of the RF signal is decreased). Moreover, the dimensions of the conductive lines 114 should fulfill an impedance-matching requirement. In order to achieve impedance matching among most RF components, a transmission line in an RF circuit must include a characteristic impedance of about 50 ohms (Ω). According to a common design principle based on a classic surface microstrip impedance equation, to achieve the 50-ohm impedance, when the signal frequency is increased to levels exceeding 10 GHz, e.g., 30 GHz, the thickness of the RDL 104 must be reduced below about 100 μm, such as below 60 μm. For example, the thickness of the RDL 104 may be between about 15 μm and about 60 μm. To achieve this, a thickness of each individual component layer of the RDL 104, e.g., the dielectric layer 112, must be significantly less than 60 μm, which is considerably less than the thickness of the common single-layer FR-4 dielectric layer 112 mentioned above. As such, the PCB-based technology for supporting FR-4 layers having thicknesses below 100 μm may not be commercially feasible. Moreover, the FR-4 based PCB material is suitable only for low-frequency RF applications, e.g., those operating in a frequency band of about 1 to 2 GHz, due to high signal loss common at high frequencies. As a result, a process of forming an RF circuit operating at a GHz frequency using current PCB-based techniques, if even possible, would incur dramatically increased costs.

Another well-known technique for forming an RDL is the fan-out panel-level process (FOPLP), which involves forming redistribution circuits on a glass-based panel using a deposition-based technique, such as chemical vapor deposition (CVD), physical vapor deposition (PVD), or the like, for forming a liquid crystal display (LCD) device. Such deposition-based techniques applied with the glass-based panel have been widely adopted in the display panel industry. A typical thickness of the RDL 204 shown in FIG. 1B formed using the FOPLP technique with a three-layer configuration is between about 2 μm and about 15 μm, well below the 100 μm-threshold required for RF signal transmission. However, since the proposed RF circuit includes a TGV-free glass substrate 202 and slits in the RDL 204 for transmitting the RF signals, the impact of the slit design should be taken into consideration. According to some embodiments, dimensions of the slits are increased as a total thickness of the RDL 204 is reduced. Nevertheless, it has been found that the signal loss of the RF signal increases when a dimension of the slit is reduced. As a result, when the total thickness of the RDL 204 is less than about 20 μm, an efficiency of the phased array antenna 200 becomes unacceptable due to high signal loss from the slits. Thus, the total thickness of the RDL 204 should be kept greater than about 20 μm. In view of the above, the FOPLP technique may also not be a good choice for forming the RDL 204 due to its inadequacy to achieve the minimum thickness requirement of the RDL 204.

To address the above issues, the present disclosure proposes a new design and a new manufacturing process for forming the RDL 204. The proposed RDL 204 is formed using a combined film forming process that utilizes a combination of a buildup film, a thin-film transistor (TFT) technique and FOPLP-based technologies. The desirable thickness of the RDL 204 can be achieved with a low-cost manufacturing process and improved RF performance at high frequencies.

Referring to FIG. 1B, according to some embodiments, the RDL 204 is formed of a plurality of metallization layers (conductive line layers or conductive via layers) in a stack. The metallization layers include patterned conductive lines and/or conductive vias, wherein such patterned conductive lines and vias are electrically interconnected to form conductive paths for transmitting RF signals.

For example, a first metallization layer M1 is a conductive line layer formed over an upper surface of a substrate 202. The first metallization layer M1 may include one or more conductive planes configured as one or more ground planes of the phased array antenna 200. According to some embodiments, the ground planes define or include one or more slits, slots or apertures used for electromagnetically coupling RF signals to or from the antenna patches 206 through the substrate 202. The first metallization layer M1 may include a metallic material, such as copper, titanium, chromium, tungsten, silver, aluminum, or another suitable metal. The first metallization layer M1 may have a thickness between about 0.5 μm and about 6 μm.

According to some embodiments, the RDL 204 further includes an adhesive layer D0 formed between the substrate 202 and the first metallization layer M1, e.g., on the upper surface of the substrate 202. The adhesive layer D0 may aid in adhesion between the first metallization layer M1 or a first dielectric layer D1 of the RDL 204 and the substrate 202. The adhesive layer D0 may have a thickness between about 1 μm and about 1.5 μm. The adhesive layer D0 may include a dielectric material, e.g., silicon nitride, silicon oxide, or another suitable material.

The first dielectric layer D1 is formed over the first metallization layer M1. The first dielectric layer D1 may include a dielectric material, such as silicon nitride, silicon oxide, a polymeric material, a photoimageable dielectric (PID) material (such as photosensitive polyimide (PSPI), photosensitive epoxy, photosensitive acrylic, photosensitive polybenzoxazole (PSPBO), photosensitive benzocyclobutene (PSBCB), siloxane-based PID, polyurethane-based PID, cyanate ester-based PID, and a combination thereof), or another suitable dielectric material. The first dielectric layer D1 may have a thickness H1, measured from a lower planar surface to an upper planar surface of the first dielectric layer D1, between about 0.5 μm and about 10 μm. According to some embodiments, the first dielectric layer D1 includes a multilayer structure, such as a sandwich structure with two silicon nitride layers and a polymeric layer between the silicon nitride layers.

A second metallization layer M2 is formed over the first dielectric layer D1 and the first metallization layer M1. The second metallization layer M2 may be a conductive line layer, which includes a plurality of conductive lines extending in a horizontal direction. The second metallization layer M2 may further include a plurality of conductive vias M2V extending in a vertical direction and electrically coupled to the first metallization layer M1. According to some embodiments, the conductive lines of the second metallization layer M2 are configured as digital signal paths to transmit digital signals, e.g., control or calibration signals, for the phased array antenna 200. The second metallization layer M2 may include a metallic material, such as copper, titanium, chromium, tungsten, silver, aluminum, or another suitable metal. The second metallization layer M2 may have a thickness between about 0.5 μm and about 6 μm.

A second dielectric layer D2 is formed over the second metallization layer M2. The second dielectric layer D2 may include a dielectric material, such as silicon nitride, silicon oxide, silicon oxynitride, silicon carbide, a polymeric material, a PID material, a combination thereof, or another suitable dielectric material. The second dielectric layer D2 may include a material similar to a material of the first dielectric layer D1. The second dielectric layer D2 may have a thickness H2, measured from a lower planar surface to an upper planar surface of the second dielectric layer D2, between about 0.5 μm and about 10 μm, or between about 1 μm and about 5 μm. According to some embodiments, the second dielectric layer D2 includes a multilayer structure, such as a sandwich structure having two silicon nitride layers and a polymer layer between the silicon nitride layers.

A third metallization layer M3 is formed over the second dielectric layer D2 and the second metallization layer M2. The third metallization layer M3 may be a conductive plane layer, which includes a plurality of conductive lines or planes extending in the horizontal direction. The third metallization layer M3 may further include a plurality of conductive vias M3V extending in the vertical direction and electrically coupled to the second metallization layer M2. According to some embodiments, the conductive lines or planes of the third metallization layer M3 are configured as ground paths or planes of the phased array antenna 200. The third metallization layer M3 may include a metallic material, such as copper, titanium, chromium, tungsten, silver, aluminum, or another suitable metal. The third metallization layer M3 may have a thickness between about 0.5 μm and about 6 μm.

A third dielectric layer D3 is formed over the third metallization layer M3. The third dielectric layer D3 may include a dielectric material, such as a polymeric material, a PID material (e.g., a dry film dielectric material), or another suitable dielectric material. As used herein, a dry film dielectric material refers to a PID material provided in the form of a solid film, which is laminated or otherwise applied to a substrate without the use of a liquid precursor. The third dielectric layer D3 may include a material different from or similar to a material of the first dielectric layer D1 or a material of the second dielectric layer D2. The third dielectric layer D3 may have a thickness H3, measured from a lower planar surface to an upper planar surface of the third dielectric layer D3, between about 15 μm and about 50 μm. The thickness H3 may comprise at least 50% of a major thickness H_{M} of the RDL 204, wherein the major thickness H_{M} is measured between an lower surface of the first dielectric layer D1 and an upper surface of the third dielectric layer D3. The thickness H3 may be at least twice the thickness H1 of the first dielectric layer D1 or at least twice the thickness H2 of the second dielectric layer D2.

A fourth metallization layer M4 is formed over the third metallization layer M3, and extends within and over the third dielectric layer D3. The fourth metallization layer M4 may be a conductive plane layer, which includes a plurality of conductive lines extending in the horizontal direction and configured as power rails and signal lines to transmit power and RF signals, respectively. The fourth metallization layer M4 may further include a plurality of conductive vias M4V extending in the vertical direction through the third dielectric layer D3 and electrically coupled to the third metallization layer M3. The fourth metallization layer M4 may include a metallic material, such as copper, titanium, tungsten, silver, or another suitable metal. The conductive lines in the fourth metallization layer M4 may have a thickness between about 4 μm and about 15 μm. The conductive vias M4V may have a width greater than a width of a line or a width of a via in the first metallization layer M1, the second metallization layer M2 or the third metallization layer M3. The conductive vias M4V may have a width greater than about 40 μm, e.g., between about 40 μm and about 70 μm. The conductive vias M2V or M3V may have a width between about 20 μm and about 40 μm. The thicknesses or the widths of the conductive lines/vias in the fourth metallization layer M4 are greater than those in the first metallization layer M1, second metallization layer M2 or the third metallization layer M3 for carrying more power and more RF signals with less resistance. According to some embodiments, a total thickness H_{T} of the RDL 204, measured from a lower surface of the first dielectric layer D1 to an upper surface of the fourth dielectric layer D4, is between about 20 μm and about 80 μm.

A fourth dielectric layer D4 is formed over the fourth metallization layer M4 and the third dielectric layer D3. The fourth dielectric layer D4 may include a dielectric material, such as a solder resist, a polymeric material, a PID material, or another suitable dielectric material. The fourth dielectric layer D4 may include a material different from or similar to materials of the first dielectric layer D1, the second dielectric layer D2 or the third dielectric layer D3. The fourth dielectric layer D4 may have a thickness between about 4 μm and about 30 μm.

A plurality of connectors 210 are formed between the RF chips 208 (see FIG. 1A) and the fourth metallization layer M4. The connectors 210 are formed to electrically connect the RF chips 208 to the conductive lines in the fourth metallization layer M4. The connectors 210 may include conductive bumps, such as controlled collapse chip connection (C4) bumps, micro-bumps, ball grid array bumps, line grid array bumps, pin grid array bumps, or another suitable type of bump. The connectors 210 may include a solder bump or a copper bump.

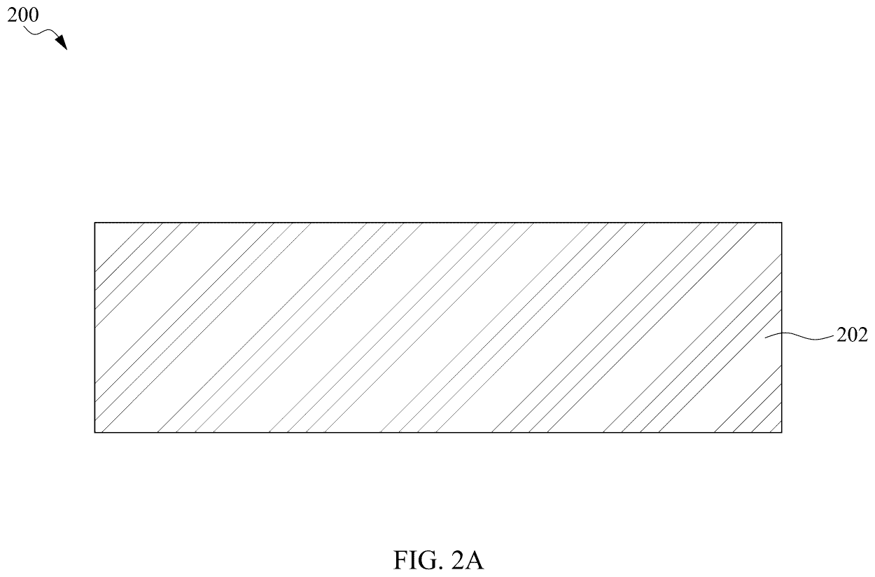

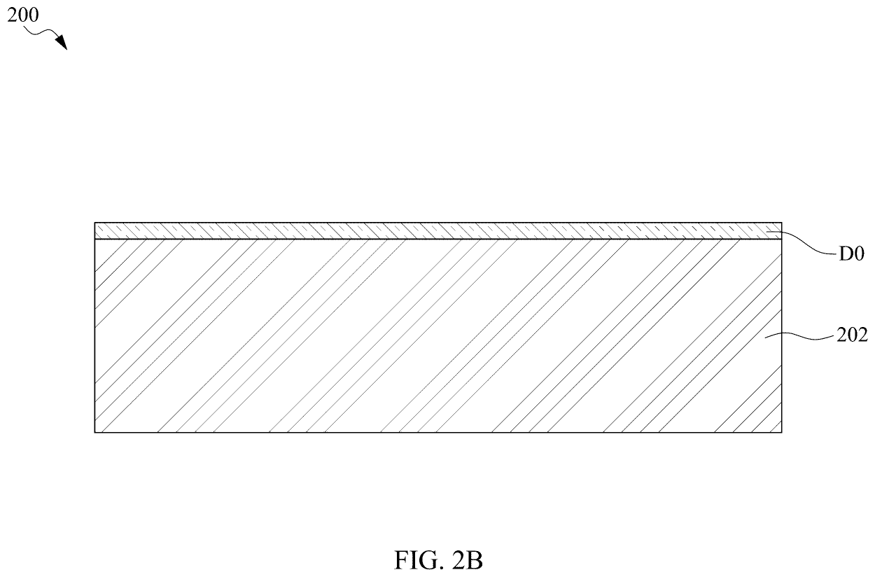

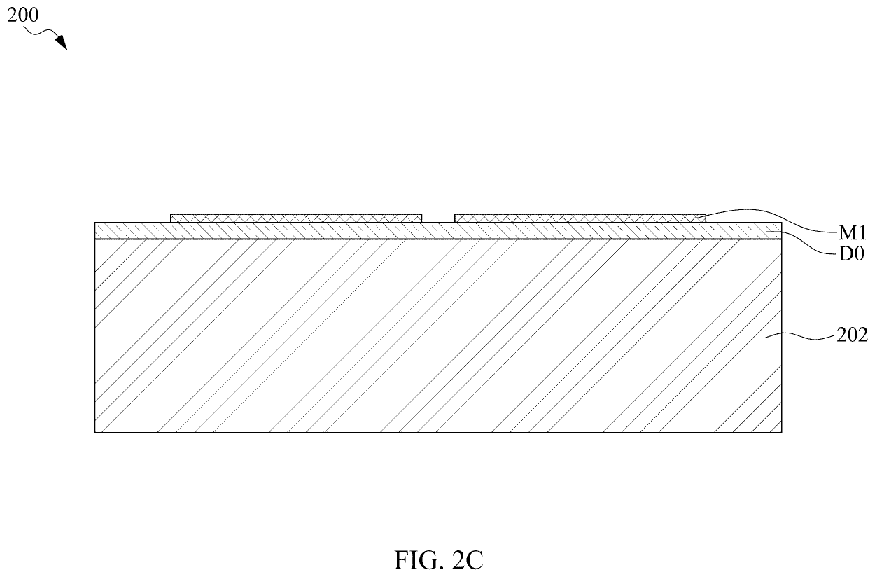

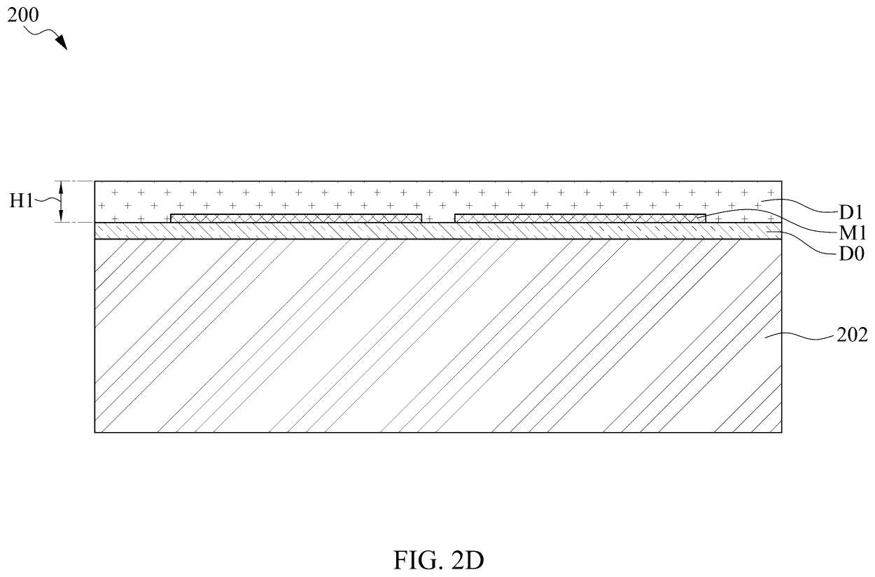

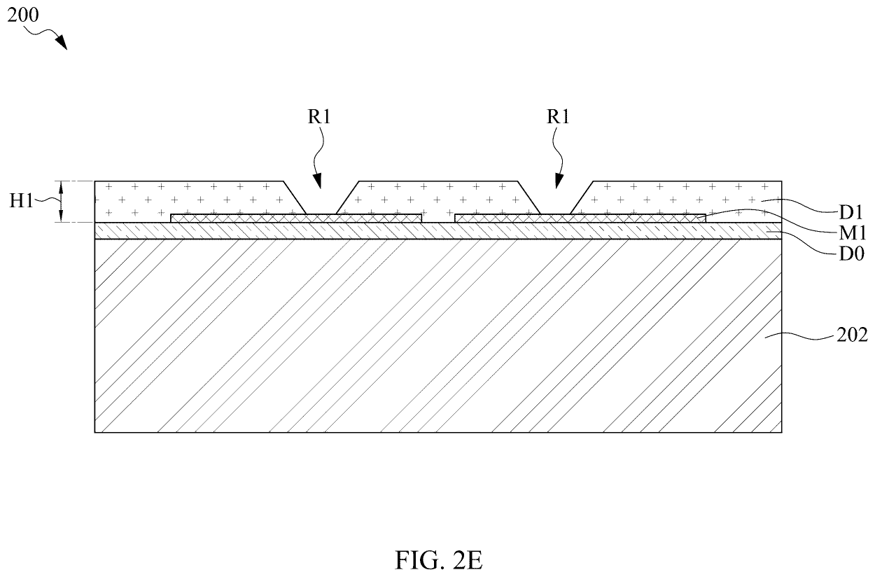

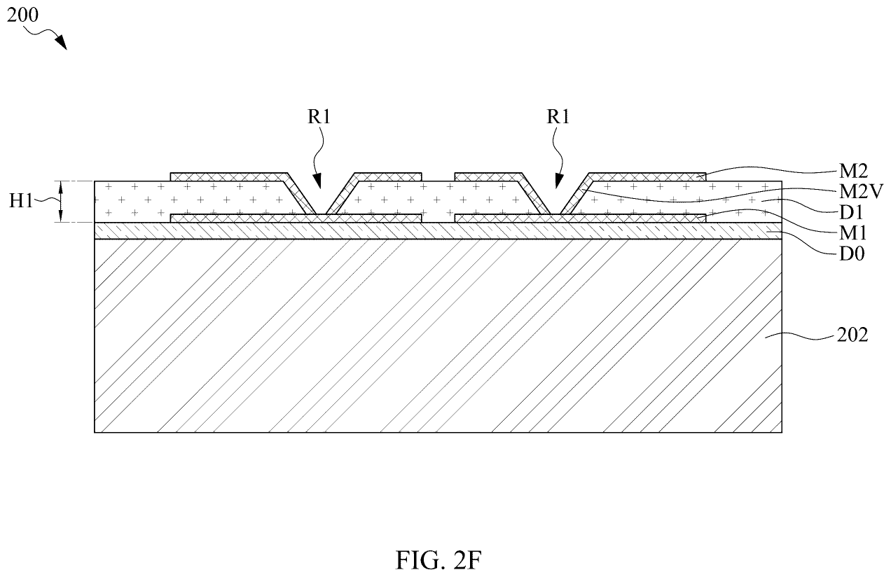

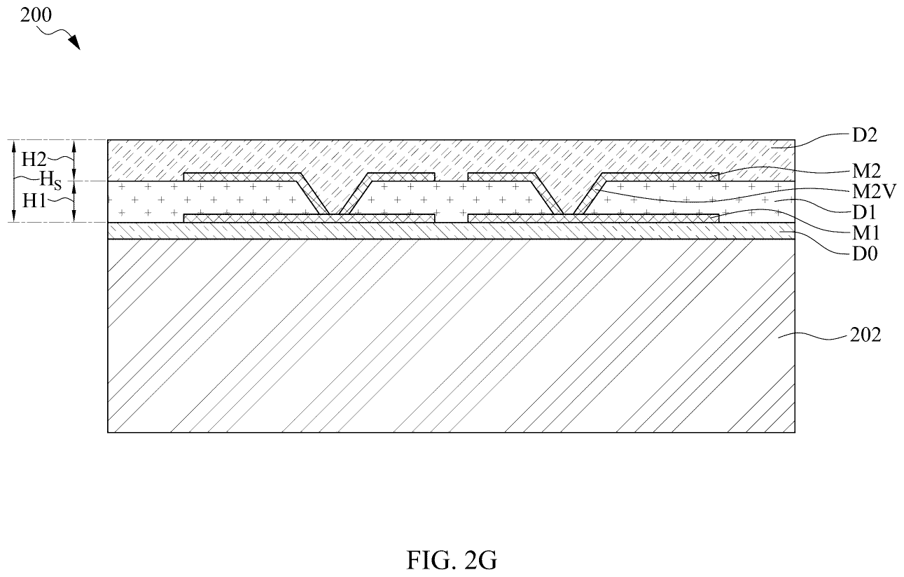

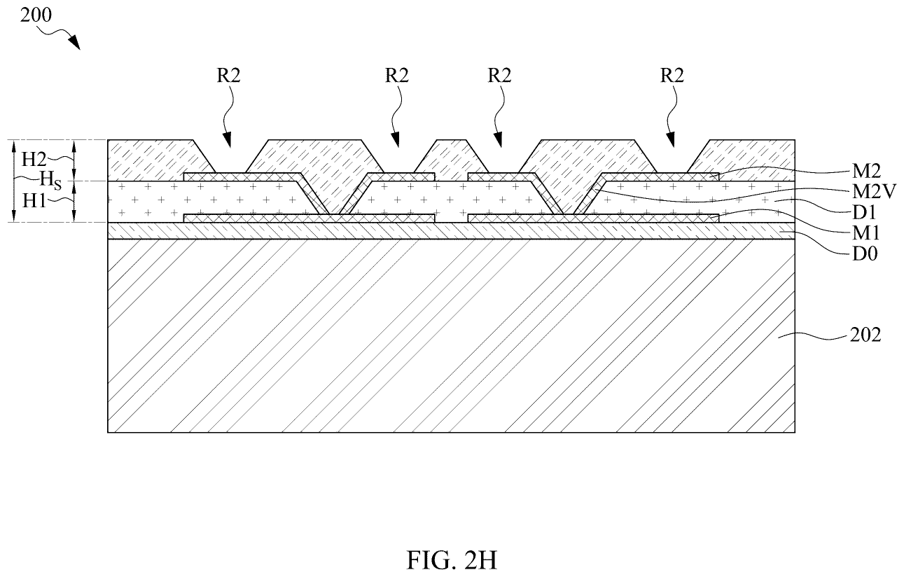

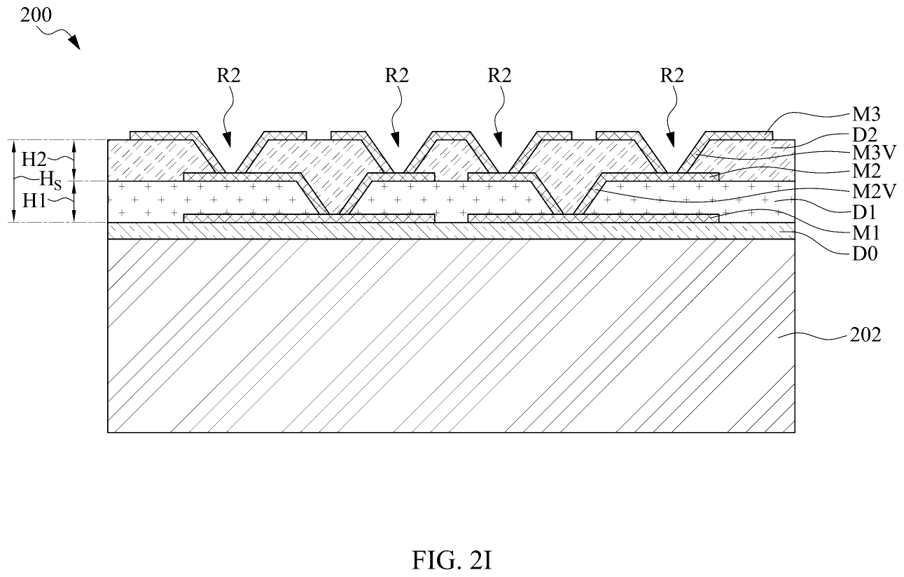

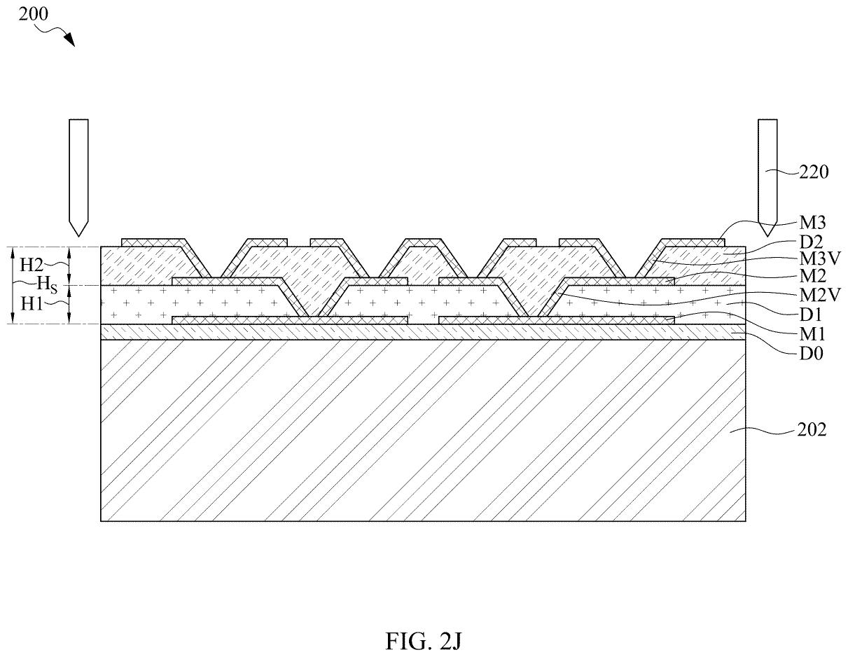

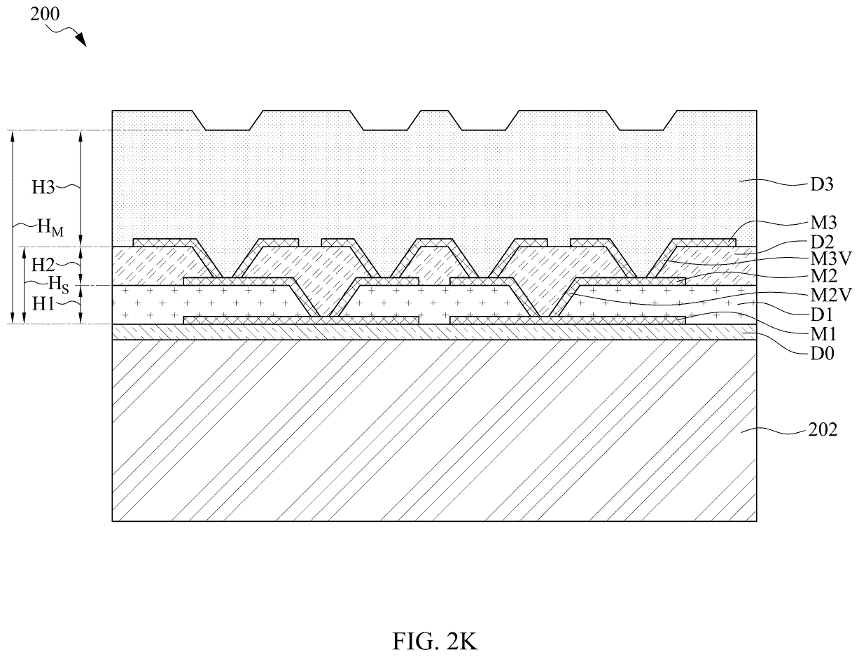

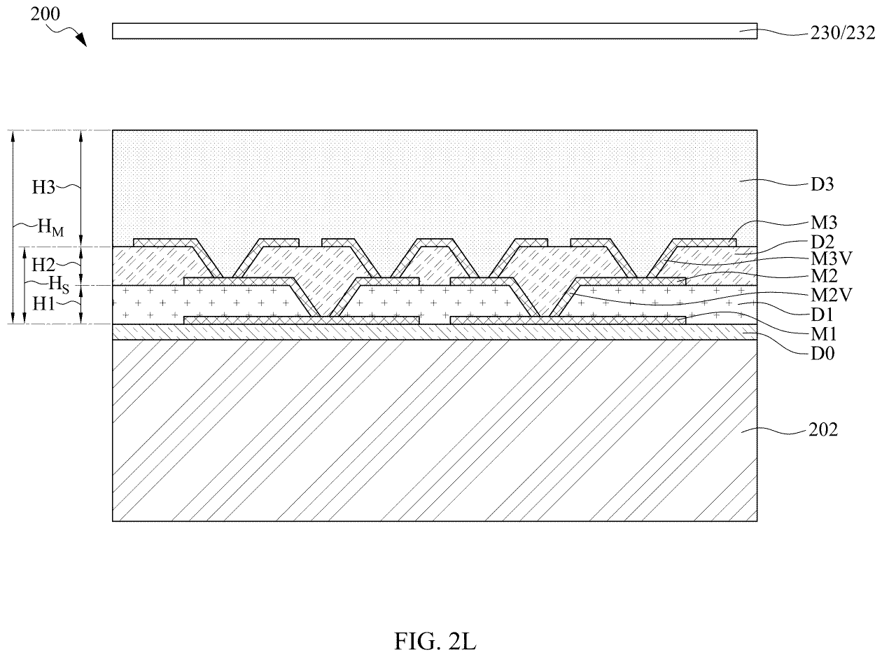

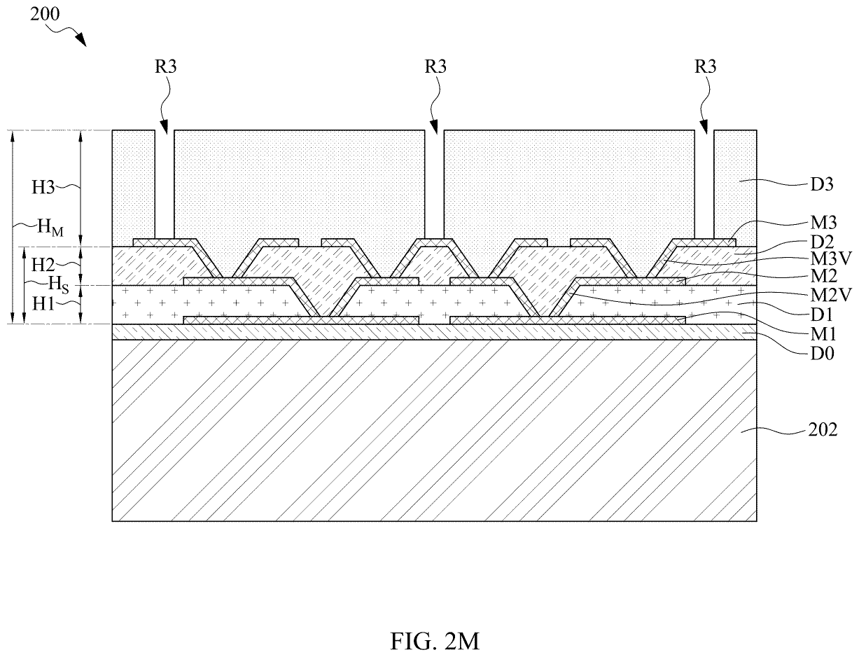

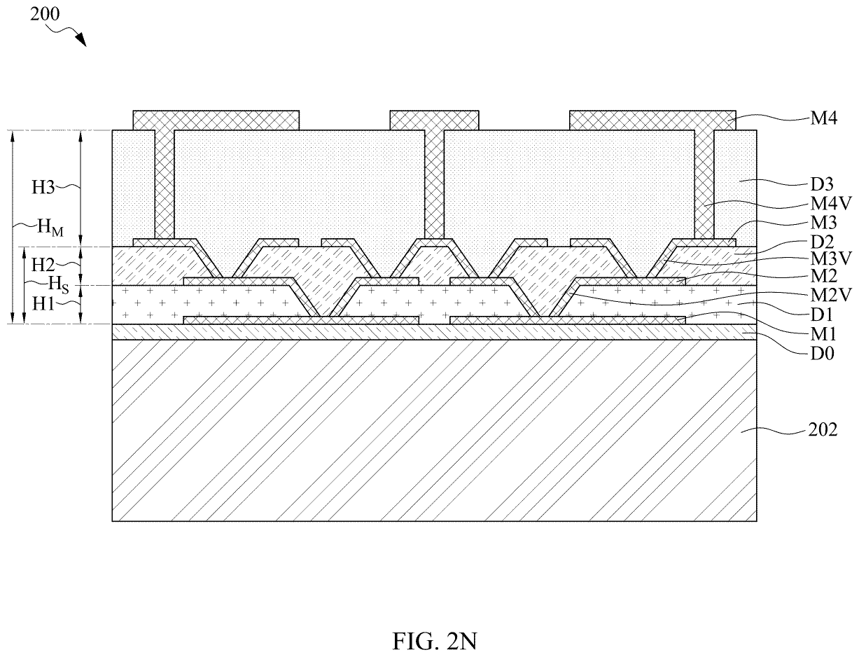

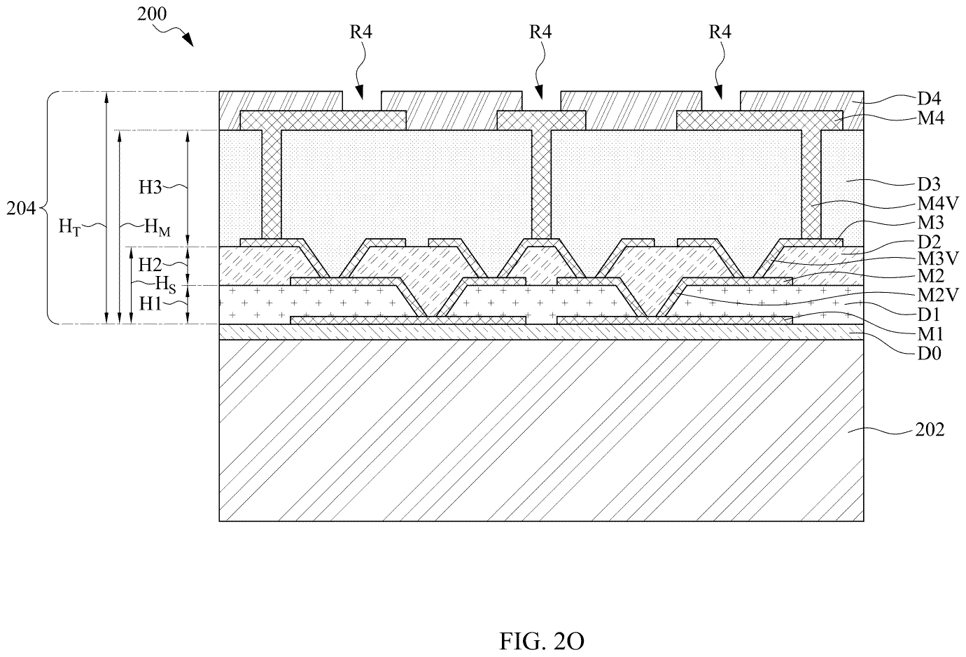

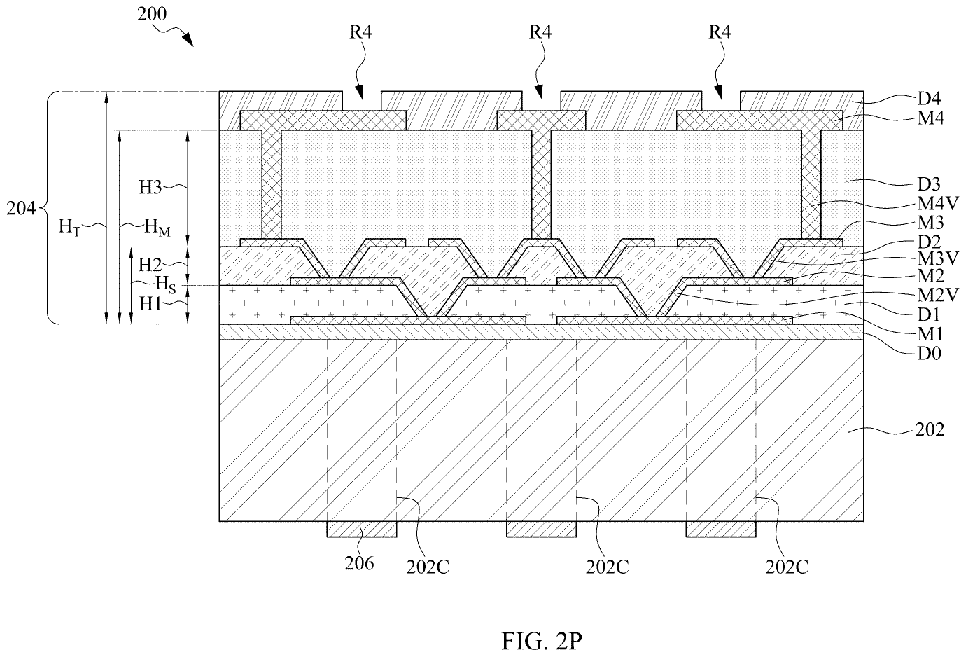

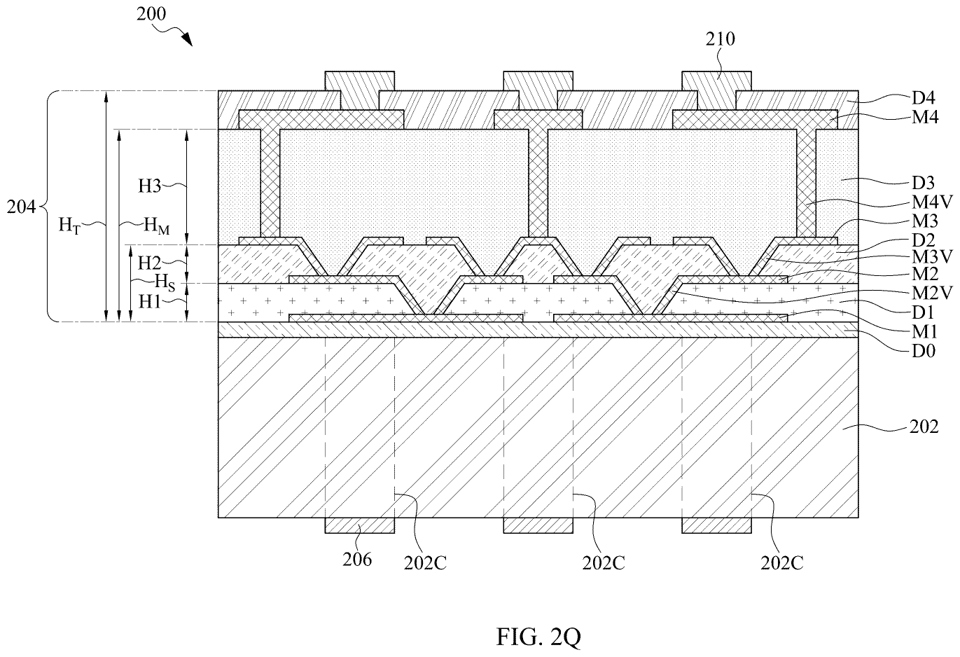

FIGS. 2A, 2B, 2C, 2D, 2E, 2F, 2G, 2H, 2I, 2J, 2K, 2L, 2M, 2N, 2O, 2P and 2Q are cross-sectional views of intermediate stages of a method of forming the phased array antenna 200, in accordance with some embodiments. It should be understood that additional steps can be provided before, during, and after the steps shown in FIGS. 2A to 2Q, and some of the steps described below can be replaced or eliminated, for additional embodiments of the method shown in FIGS. 2A to 2Q. An order of the steps may be changed.

Referring to FIG. 2A, a substrate 202 is provided or received. According to some embodiments, the substrate 202 is a glass-based substrate, and includes glass, fused silica, silicon oxide, quartz, or another suitable material. The substrate 202 may be transparent in color and transparent to RF signals. Referring to FIG. 2B, an adhesive layer D0 is deposited over an upper surface of the substrate 202. The adhesive layer D0 may comprise silicon nitride, silicon oxide, or another suitable adhesive material, and may be formed by a deposition process such as CVD, PVD, spin coating, or another suitable deposition process. The adhesive layer D0 may have a thickness between about 1 μm and about 1.5 μm.

Referring to FIG. 2C, a first metallization layer M1 is formed over the adhesive layer D0 and the substrate 202. The first metallization layer M1 may include a metallic material, such as copper, titanium, chromium, tungsten, silver, aluminum, or another suitable metal. The first metallization layer M1 may have a thickness between about 0.5 μm and about 6 μm. The first metallization layer M1 may be formed by deposition, photolithography and etching processes. The deposition process may include PVD, CVD, or another suitable deposition process. The deposition process of the first metallization layer M1 may be similar to that used in existing LCD metal line deposition processes. The LCD metal line deposition process is more cost-effective than those used to form high-density interconnect structures for PCB applications.

Referring to FIG. 2D, a first dielectric layer D1 is deposited over the first metallization layer M1 and the substrate 202. The first dielectric layer D1 may have a thickness H1 between about 0.5 μm and about 10 μm. The first dielectric layer D1 may be formed by PVD, CVD, or another suitable deposition process. According to some embodiments, a planarization process, such as mechanical grinding or chemical mechanical polishing (CMP), is performed to level an upper surface of the first dielectric layer D1.

Referring to FIG. 2E, the first dielectric layer D1 is patterned to form recesses R1. The recesses R1 may expose a portion of conductive planes or conductive lines in the first metallization layer M1. The recesses R1 may be formed using a photolithography operation, which includes, e.g., exposure, post-exposure bake, development and curing.

FIG. 2F illustrates formation of a second metallization layer M2 over the first dielectric layer D1 and within the recesses R1. According to some embodiments, conductive planes or conductive lines arranged in the second metallization layer M2 and conductive vias M2V arranged within the recess R1 are formed conformal to the upper surface of the first dielectric layer D1. The recesses R1 are only partially filled by the conductive vias M2V of the second metallization layer M2. The second metallization layer M2 may have a thickness between about 0.5 μm and about 6 μm. The conductive via M2V of the second metallization layer M2 may have a width between about 20 μm and about 40 μm. The second metallization layer M2 may be formed using deposition, photolithography and etching processes. The deposition process may include PVD, CVD, or another suitable deposition process. The deposition process of the second metallization layer M2 may be similar to those used in existing LCD metal line deposition processes.

Referring to FIG. 2G, a second dielectric layer D2 is deposited over the first metallization layer M1 and the first dielectric layer D1. The second dielectric layer D2 may have a thickness H2 between about 0.5 μm and about 10 μm, or between about 1 μm and about 5 μm. According to some embodiments, the second dielectric layer D2 includes a multilayer structure, such as a sandwich structure, which is formed by depositing a first silicon nitride layer, a polymer layer and a second silicon nitride layer in a stack. The second dielectric layer D2 may be formed using PVD, CVD, or another suitable deposition process. Materials, the thickness, and the method of forming the second dielectric layer D2 may be similar to those of the first dielectric layer D1.

Referring to FIG. 2H, the second dielectric layer D2 is patterned to form recesses R2. The recesses R2 may expose a portion of the conductive planes or the conductive lines in the second metallization layer M2. The recesses R2 may be formed using a photolithography operation.

FIG. 2I illustrates formation of a third metallization layer M3 over the second dielectric layer D2 and within the recesses R2. According to some embodiments, conductive planes or conductive lines arranged in the third metallization layer M3 and conductive vias M3V arranged within the recess R2 are formed conformal to a top surface of the second dielectric layer D2. The recesses R2 are only partially filled by the conductive vias M3V of the third metallization layer M3. The third metallization layer M3 may have a thickness between about 0.5 μm and about 6 μm. The conductive via M3V of the third metallization layer M3 may have a width between about 20 μm and about 40 μm. The third metallization layer M3 may be formed using deposition, photolithography and etching processes. The deposition process may include PVD, CVD, or another suitable deposition process. The deposition process of the third metallization layer M3 may be similar to that used in existing LCD metal line deposition processes. Materials, the thickness, and the method of forming the third metallization layer M3 may be similar to those of the second metallization layer M2.

As described above, high planarity of the substrate 202 may be beneficial to successful formation of the phased array antenna 200. A glass-based material is therefore adopted for the substrate 202 due to its high planarity and low cost as compared to other material options. However, during the formation of constituent layers of the RDL 204, e.g., the first dielectric layer D1 and the second dielectric layer D2, one or more thermal operations may be performed on the RDL 204 and the substrate 202. The material of the substrate 202, the dielectric material of the first dielectric layer D1 and the material of the second dielectric layer D2 may include different coefficients of thermal expansion (CTE). As a result, a CTE mismatch between the substrate 202, the first dielectric layer D1 and the second dielectric layer D2 may generate stress that causes a warpage of the substrate 202. For example, different stresses exerted on a front side and on a back side of the substrate 202 due to CTE mismatch may cause the substrate 202 to warp. Such warpage may be more severe in applications where the substrate 202 is larger, such as a panel substrate with dimensions of about 220 cm×250 cm or greater.

To address the abovementioned issues, the present disclosure proposes a method to control the thickness H1 of the first dielectric layer D1 and the thickness H2 of the second dielectric layer D2. When the thickness H1 or H2 is controlled within a predetermined range, the stress induced by the CTE mismatch is reduced, and the warpage effect is reduced to an acceptable level that does not seriously affect subsequent processes of the RDL 204. According to some embodiments, the thickness H1 or H2 is limited to between about 0.5 μm and about 10 μm. According to some embodiments, a thickness sum H_{S} of the thicknesses H1 and H2 is kept between about 2 μm and about 20 μm. If the thickness H1 or H2 is less than about 0.5 μm, performance of electrical insulation provided by the first dielectric layer D1 or the second dielectric layer D2 will be reduced, and performance of the first metallization layer M1, the second metallization layer M2 and the third metallization layer M3 will be negatively impacted. However, if the thickness sum H_{S} of the thicknesses H1 and H2 is greater than about 20 μm, the warpage effect will cause reliability issues of the RDL 204.

According to some embodiments, a total thickness H_{T}, measured between a lower surface of the first dielectric layer D1 and an upper surface of the fourth dielectric layer D4, is between about 20 μm and about 80 μm. According to some embodiments, a major thickness H_{M}, measured between the lower surface of the first dielectric layer D1 and an upper surface of a third dielectric layer D3, is between about 15 μm and about 60 μm. According to some embodiments, a ratio of the thickness sum H_{S} to the major thickness H_{M} is equal to or less than 50%, less than 40%, or less than 33.3%.

Existing RDL structures, such as the RDL 104 shown in FIG. 5, are formed with a plurality of metallization layers and a plurality of dielectric layers, wherein thicknesses of the dielectric layers are substantially equal, and materials or layer constructions of the dielectric layers are identical for achieving uniform insulation performance and reducing design complexity. However, an application of such design in an ordinary RDL structure or a PCB structure using a laminate substrate or a semiconductor (e.g., silicon) substrate would not be adequate to resolve problems encountered in the RDL 104 that would be otherwise formed on a glass-based substrate 202.

Furthermore, to effectively mitigate the warpage issue mentioned above, and to expand a process window for the range of the thickness H1 or H2, it is further proposed to reduce a size of the substrate 202 prior to formation of the third dielectric layer D3. Referring to FIG. 2J, a dicing or sawing operation is performed on the phased array antenna 200 to cut the substrate 202 into smaller substrate units. The substrate units after the dicing operation are also labelled with numeral 202 for ease of discussion. According to some embodiments, the dicing or sawing operation is performed by a cutting tool 220, such as a laser blade, a diamond blade, or another suitable cutting tool. After the dicing or sawing operation, the substrate 202 is divided into four or any suitable number of substrate units 202. According to some embodiments, each of the cut substrate units 202 may include a substrate area accommodating one or more phased array antennas 200.

Referring to FIG. 2K, a material of the third dielectric layer D3 is disposed over the third metallization layer M3 and the second dielectric layer D2. The material of the third dielectric layer D3 may include a dielectric material, such as a polymeric material, a PID material (e.g., a dry film dielectric material), or another suitable dielectric material. The third dielectric layer D3 may include a material different from a material of the first dielectric layer D1 or the second dielectric layer D2. The third dielectric layer D3 may have a thickness H3 between about 10 μm and about 50 μm. The thickness H3 comprises at least 50% of the major thickness H_{M} of the RDL 204. The thickness H3 may be at least twice the thickness H1 of the first dielectric layer D1 or at least twice the thickness H2 of the second dielectric layer D2. When the material of the third dielectric layer D3 is in a form of dry film, it is disposed on the surface of the phase array antenna 200.

Referring to FIG. 2L, a pressing operation is performed on the third dielectric layer D3. The pressing operation is performed by a pressing tool 230 that exerts a downward force at a heated environment to bond the third dielectric layer D3 to the third metallization layer M3 and the second dielectric layer D2 for facilitating adhesion between the third dielectric layer D3 and the third metallization layer M3 or the second dielectric layer D2. According to some embodiments, the pressing operation includes a planarization operation that can aid in obtaining a relatively flat surface of the third dielectric layer D3.

According to some embodiments, the operations of film disposing and film pressing are completed through a lamination process. The lamination process may include the material disposing step and the pressing step shown in FIGS. 2K and 2L, respectively. According to some embodiments, the lamination process involves using heat and pressure to transfer a dry film dielectric material from a carrier sheet to the phased array antenna 200. A laminator 232 may be utilized to perform the lamination process using the dry film dielectric material of the third dielectric layer D3 to laminate the third dielectric layer D3 to the second dielectric layer D2 and the third metallization layer M3. The lamination process may be performed by a vacuum laminator 232 to improve a bonding or the lamination between the third dielectric layer D3 and the third metallization layer M3 or the second dielectric layer D2.

The laminating material of the third dielectric layer D3 is advantageous in that its thickness can be made much greater than that of the first dielectric layer D1 and the second dielectric layer D2, which are formed using deposition processes for LCD applications. As a result, the major thickness H_{M} of the RDL 204, which is measured between the upper surface of the first metallization layer M1 and the upper surface of the third dielectric layer D3, can be corresponding to a wavelength of an RF signal. However, since the third dielectric layer D3 needs to be formed through lamination, a non-trivial downward pressure is exerted on the phased array antenna 200, and the constituent layers of the RDL 204 and the substrate 202 must be kept sufficiently planar or flat to prevent the downward pressure from damaging the warpage-prone substrate 202, especially when the substrate 202 is made of glass-based materials. Thus, effective warpage management may be beneficial to successful completion of the lamination of the third dielectric layer D3. As described above, the thickness H1 of the first dielectric layer D1 and the thickness H2 of the second dielectric layer D2 are kept within a predetermined range, and the large substrate 202 is cut into smaller substrate units 202. One or both of the abovementioned measures are used to reduce a degree or a likelihood of warpage of the substrate 202 and to thereby decrease a degree of damage to the substrate units 202 during the lamination of the third dielectric layer D3.

Referring to FIG. 2M, trenches or recesses R3 are formed through the third dielectric layer D3. The trenches R3 expose portions of the third metallization layer M3. According to some embodiments, the trenches R3 are etched using a laser drilling operation. A focused laser beam is employed to melt or vaporize the material of the third dielectric layer D3 at predetermined locations of the trenches R3. According to some embodiments, the etching of the trench R3 does not involve photolithography operations. The trenches R3 may include substantially vertical sidewalls, in contrast to the conductive vias M2V and M3V of the second metallization layer M2 and the third metallization layer M3, which are V-shaped. According to some embodiments, the trenches R3 have substantially uniform widths along the depth of the third dielectric layer D3. The width of the trenches R3 may be greater than about 40 μm, e.g., between about 40 μm and about 70 μm.

Referring to FIG. 2N, a fourth metallization layer M4 is formed through the third dielectric layer D3 and extending over the third dielectric layer D3. The fourth metallization layer M4 includes horizontal conductive lines extending over the third dielectric layer D3 and conductive vias M4V extending through the third dielectric layer D3. The conductive lines in the fourth metallization layer M4 may have a thickness between about 4 μm and about 15 μm. A width of the conductive via M4V may be greater than about 40 μm, e.g., between about 40 μm and about 70 μm. A photolithography process may be used to pattern the conductive lines or planes of the fourth metallization layer M4 over the third dielectric layer D3. A conductive material of the fourth metallization layer M4 is formed using a deposition process, e.g., electrochemical deposition (ECD) or another suitable deposition process.

Referring to FIG. 2O, a fourth dielectric layer D4 is deposited and patterned over the third dielectric layer D3 and the fourth metallization layer M4. The fourth dielectric layer D4 may include a dielectric material, e.g., solder resist, a polymeric material, a PID material, or another suitable material. The fourth dielectric layer D4 may be different from the first dielectric layer D1 or the second dielectric layer D2. The fourth dielectric layer D4 may have a thickness between about 4 μm and about 30 μm. The fourth dielectric layer D4 may be formed using deposition processes. The deposition process may include CVD, PVD, silkscreen printing, spraying or another suitable deposition process. The patterning operation of the fourth dielectric layer D4 may include a photolithography operation, or screen-printing processes. The patterned fourth dielectric layer D4 includes recesses R4. Portions of the fourth metallization layer M4 are exposed through the recesses R4.

Referring to FIG. 2P, a plurality of antenna patches 206 are formed on a lower surface of the substrate 202. The antenna patches 206 may include metal pastes formed using a screen-printing operation with a silk screen.

Referring to FIG. 2Q, a plurality of connectors 210 are formed in the recesses R4. The connectors 210 may include conductive bumps, such as controlled collapse chip connection (C4) bumps, micro-bumps, ball grid array bumps, line grid array bumps, pin grid array bumps, or another suitable type of bump. The connectors 2101 may include a solder bump or a copper bump.

Although not separately shown, a plurality of RF chips 208 are bonded to the fourth metallization layer M4 through the connectors 210. The RF chips 208 may be bonded to the fourth metallization layer M4 prior to or subsequent to the formation of the antenna patches 206.

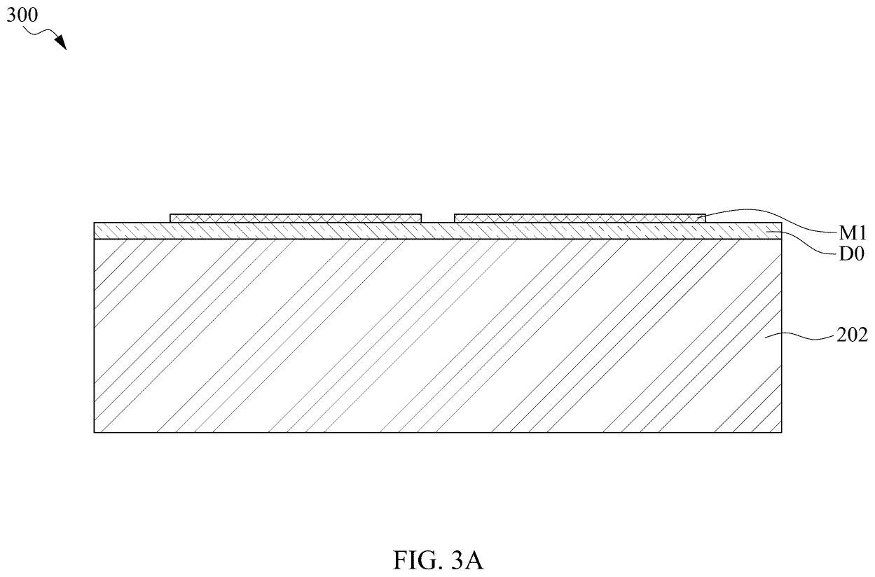

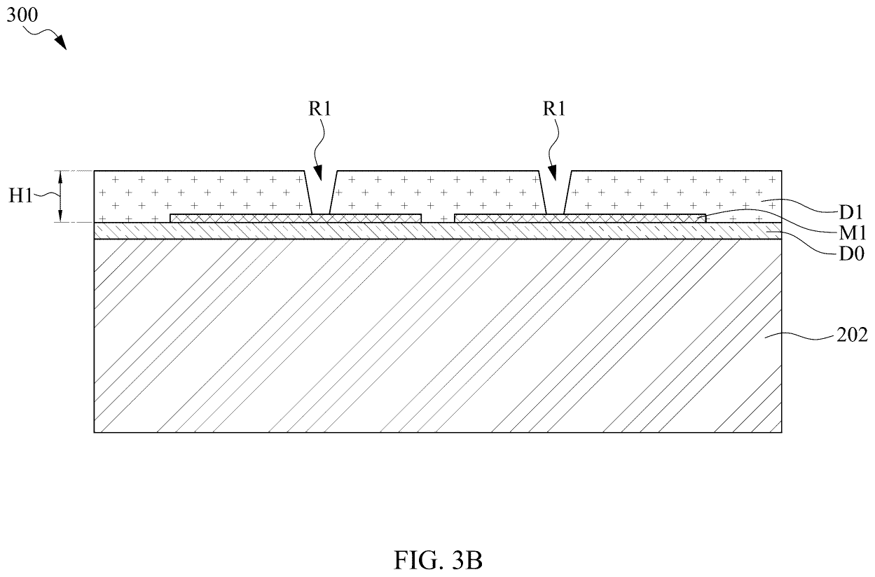

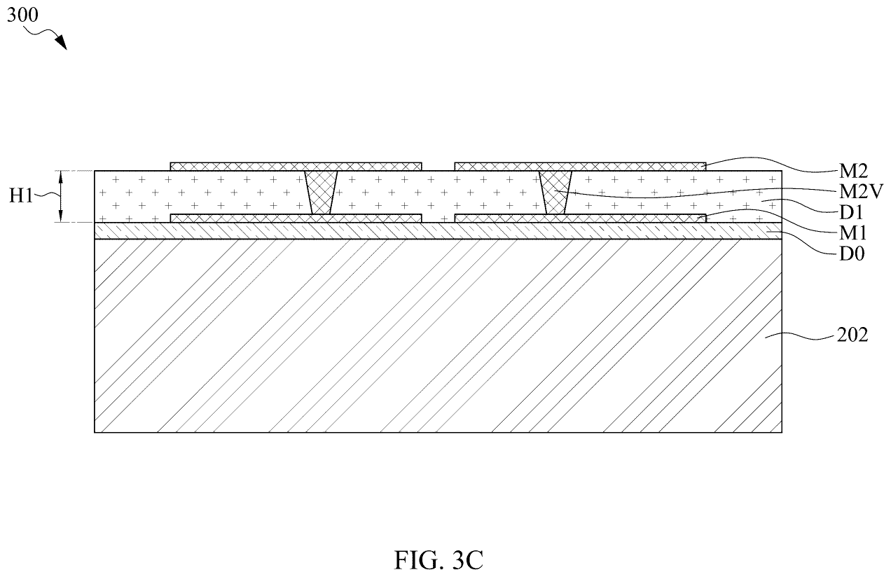

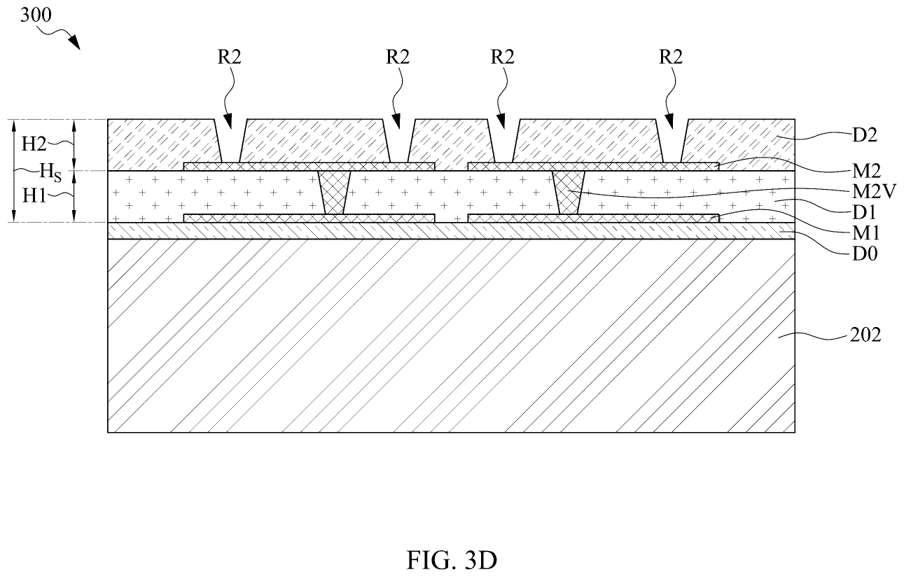

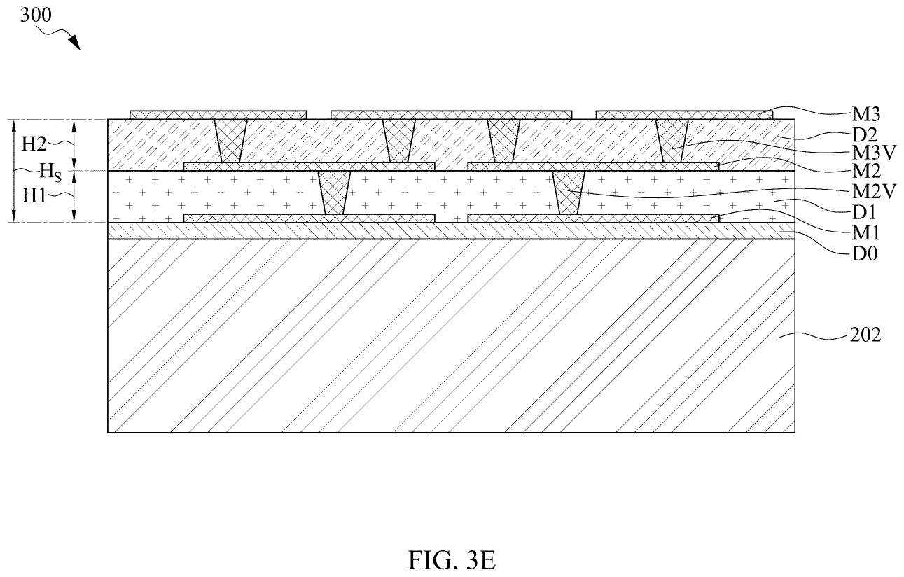

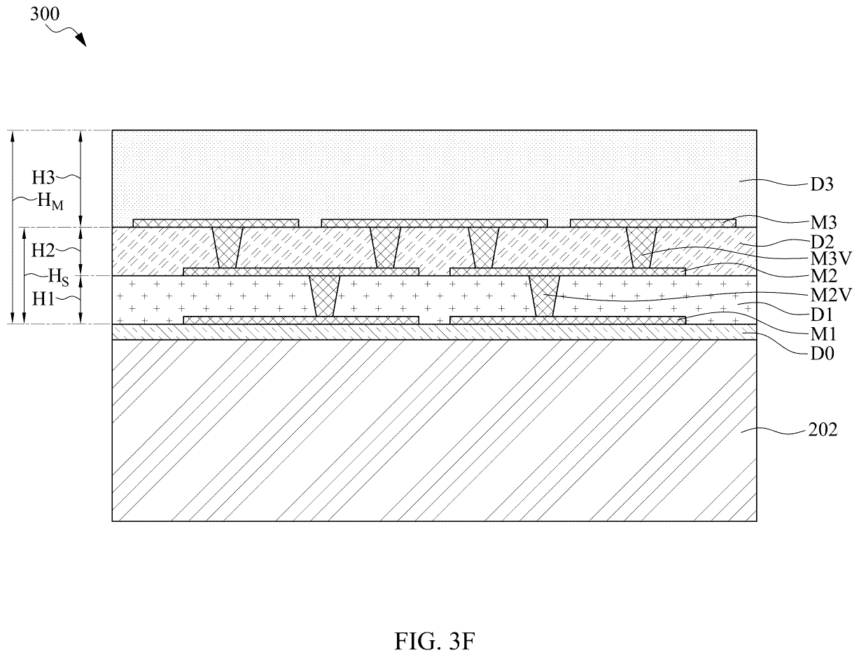

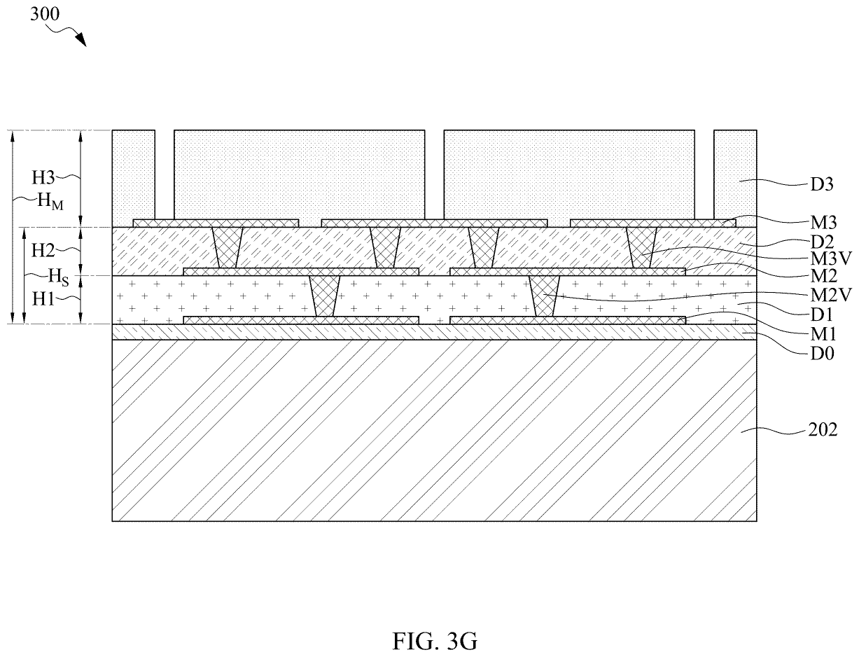

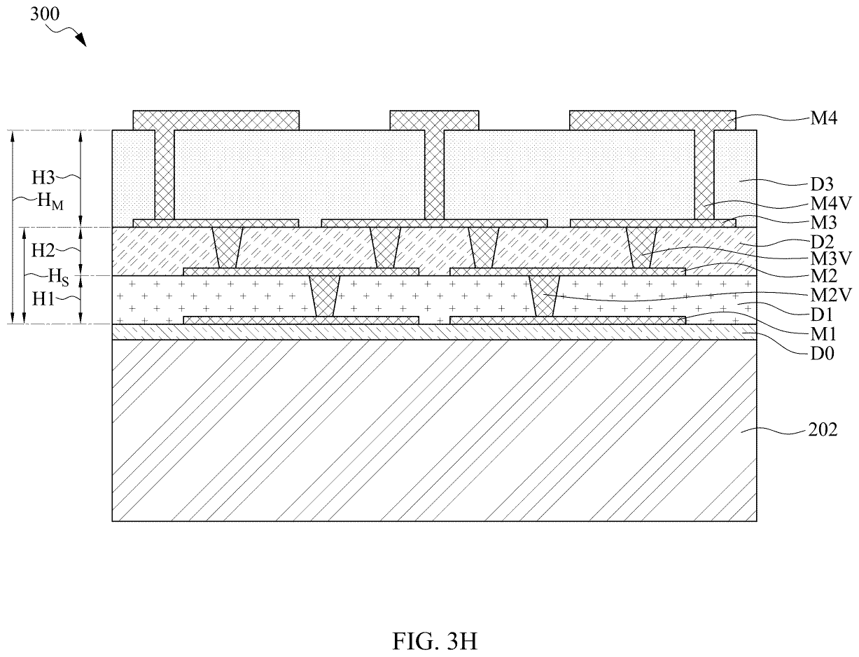

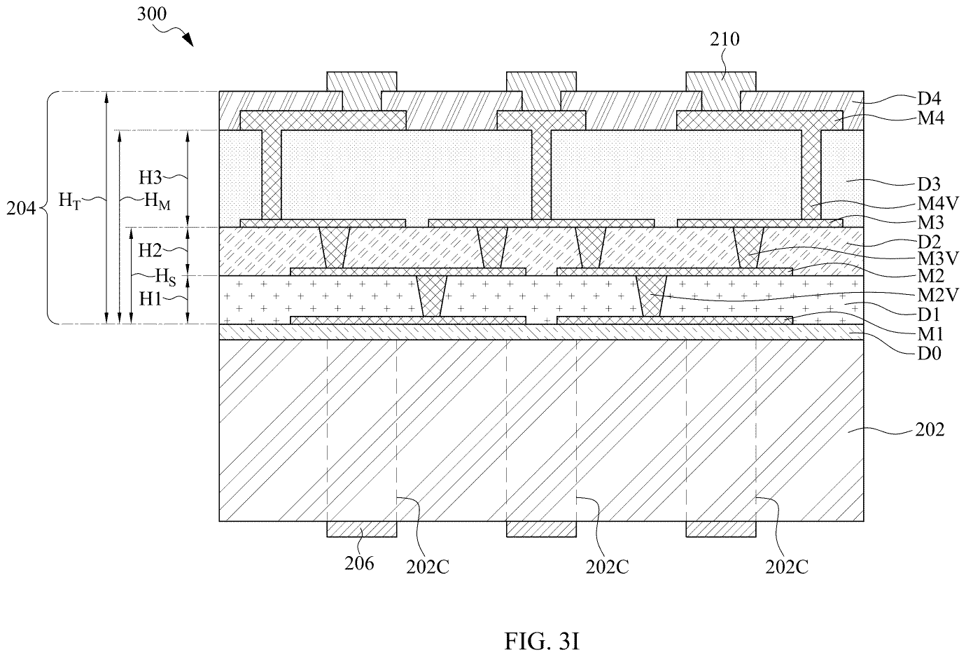

FIGS. 3A, 3B, 3C, 3D, 3E, 3F, 3G, 3H and 3I are cross-sectional views of intermediate stages of a method of forming a phased array antenna 300, in accordance with some embodiments. It should be understood that additional steps can be provided before, during, and after the steps shown in FIGS. 3A to 3I, and some of the steps described below can be replaced or eliminated, for additional embodiments of the method shown in FIGS. 3A to 3I. An order of the steps may be changed. The method of forming the phased array antenna 300 is similar to that of forming the phased array antenna 200 in many aspects, and thus descriptions of similar features are omitted for brevity.

Referring to FIG. 3A, a substrate 202 is received or provided. An adhesive layer D0 is deposited over an upper surface of the substrate 202, and a first metallization layer M1 is formed and patterned over the adhesive layer D0. Materials, configurations and methods of forming the substrate 202, the adhesive layer D0 and the first metallization layer M1 are similar to those described with reference to FIGS. 2A to 2C for forming the phased array antenna 200. According to some embodiments, the first metallization layer M1 includes titanium and copper and is formed using PVD, e.g., sputtering. According to some other embodiments, the first metallization layer M1 includes copper and is formed using an ECD process. According to some embodiments, conductive planes or conductive lines of the first metallization layer M1 have a thickness between about 0.5 μm and about 6 μm.

Referring to FIG. 3B, a first dielectric layer D1 is deposited and patterned over the first metallization layer M1 and the adhesive layer D0. According to some embodiments, the first dielectric layer D1 includes a PID layer, such as dry film dielectric material, or another suitable insulating material. The first dielectric layer D1 may be formed by a lamination process. According to some embodiments, the first dielectric layer D1 is patterned to form recesses R1 using a photolithography operation. According to some embodiments, the first dielectric layer D1 has a thickness H1 between about 0.5 μm and about 10 μm.

Referring to FIG. 3C, a second metallization layer M2 is formed over the first dielectric layer D1 and in the recesses R1 of the first dielectric layer D1. According to some embodiments, the second metallization layer M2 includes titanium and copper and is formed using PVD, e.g., sputtering. According to some other embodiments, the second metallization layer M2 includes copper and is formed using an ECD process. According to some embodiments, conductive planes or conductive lines of the second metallization layer M2 or a conductive via M2V have a thickness between about 0.5 μm and about 6 μm. The conductive via M2V may have a width between about 20 μm and about 40 μm.

Referring to FIG. 3D, a second dielectric layer D2 is deposited and patterned to form recesses R2 over the second metallization layer M2 and the first dielectric layer D1. According to some embodiments, the second dielectric layer D2 includes a PID layer, such as a dry film dielectric material, or another suitable insulating material. The second dielectric layer D2 may be formed by a lamination process. According to some embodiments, the second dielectric layer D2 is patterned to form the recesses R2 using a photolithography operation. According to some embodiments, the second dielectric layer D2 has a thickness H2 between about 0.5 μm and about 10 μm.

Referring to FIG. 3E, a third metallization layer M3 is formed over the second dielectric layer D2 and in the recesses R2 of the second dielectric layer D2. According to some embodiments, the third metallization layer M3 includes titanium and copper and is formed using PVD, e.g., sputtering. According to some other embodiments, the third metallization layer M3 includes copper and is formed using an ECD process. According to some embodiments, conductive planes or conductive lines of the third metallization layer M3 have a thickness between about 0.5 μm and about 6 μm.

Referring to FIG. 3F, a third dielectric layer D3 is deposited over the third metallization layer M3. According to some embodiments, the third dielectric layer D3 includes a PID layer, such as a dry film dielectric material, or another suitable insulating material similar to those of the first dielectric layer D1 or the second dielectric layer D2. The third dielectric layer D3 may be formed by a lamination process. According to some embodiments, the third dielectric layer D3 has a thickness between about 15 μm and about 50 μm.

According to some embodiments, the thickness H1 of the first dielectric layer D1 or the thickness H2 of the second dielectric layer D2 is limited to between about 0.5 μm and about 10 μm. According to some embodiments, a thickness sum H_{S} of the thicknesses H1 and H2 is limited to between about 2 μm and about 20 μm. If the thickness H1 or H2 is less than about 0.5 μm, performance of electrical insulation provided by the first dielectric layer D1 or the second dielectric layer D2 will be reduced, and performance of the first metallization layer M1, the second metallization layer M2 and the third metallization layer M3 will be negatively impacted. However, if the thickness sum H_{S} of the thicknesses H1 and H2 is greater than about 20 μm, a warpage effect will cause reliability issues of RDL 204.

According to some embodiments, a major thickness H_{M}, measured between a lower surface of the first dielectric layer D1 and an upper surface of the third dielectric layer D3, is between about 15 μm and about 60 μm. According to some embodiments, a ratio of the thickness sum H_{S} to the major thickness H_{M} is approximately equal to or less than 50%, less than 40%, or less than 33.3%.

Although not separately shown, the phased array antenna 300 is subjected to a dicing or sawing operation before the third dielectric layer D3 is deposited and pressed, or, alternatively, laminated, to the third metallization layer M3 and the second dielectric layer D2 in a manner similar to that described with reference to FIGS. 2K and 2L.

Referring to FIG. 3G, the third dielectric layer D3 is patterned to form trenches R3 through the third dielectric layer D3. According to some embodiments, the trenches R3 are formed by laser drilling operations. Subsequently, as shown in FIG. 3H, the fourth metallization layer M4 is formed over the third dielectric layer D3 and in the trenches R3. The fourth metallization layer M4 may be formed using deposition, photolithography and etching operations. According to some embodiments, the fourth metallization layer M4 includes titanium and copper and is formed using PVD, e.g., sputtering. According to some other embodiments, the fourth metallization layer M4 includes copper and is formed using an ECD process. According to some embodiments, conductive planes or conductive lines of the fourth metallization layer M4 have a thickness between about 4 μm and about 15 μm. According to some embodiments, conductive vias M4V of the fourth metallization layer M4 have a width greater than about 40 μm, e.g., between about 40 μm and about 70 μm.

Referring to FIG. 3I, a fourth dielectric layer D4, antenna patches 206 and connectors 210 are deposited and patterned on the phased array antenna 300. Materials, configurations and methods of forming the fourth dielectric layer D4, the antenna patches 206 and the connectors 210 are similar to those described with reference to FIGS. 2O to 2R for the formation of the phased array antenna 200.

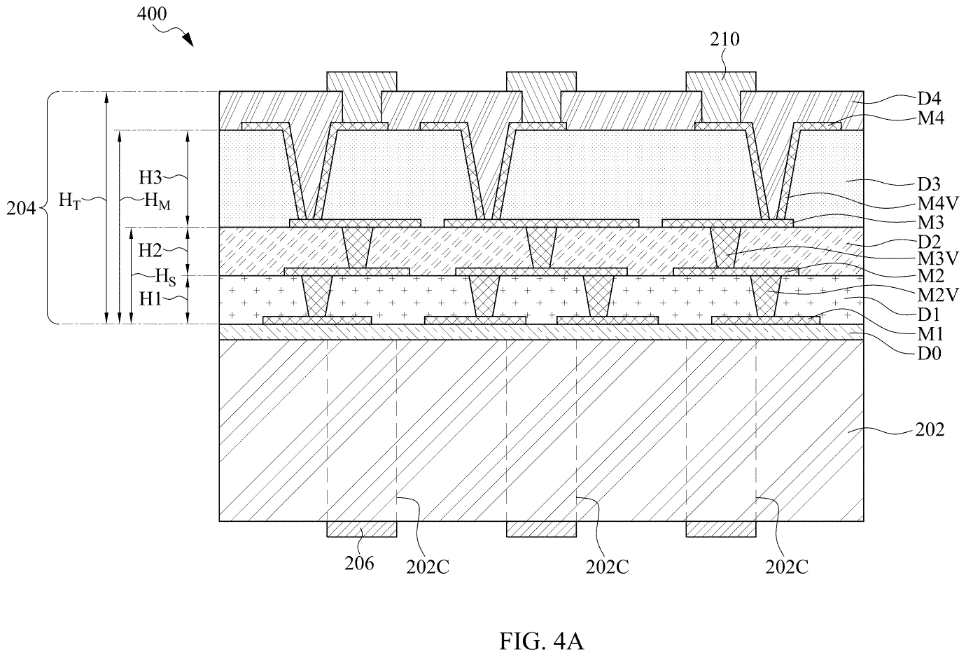

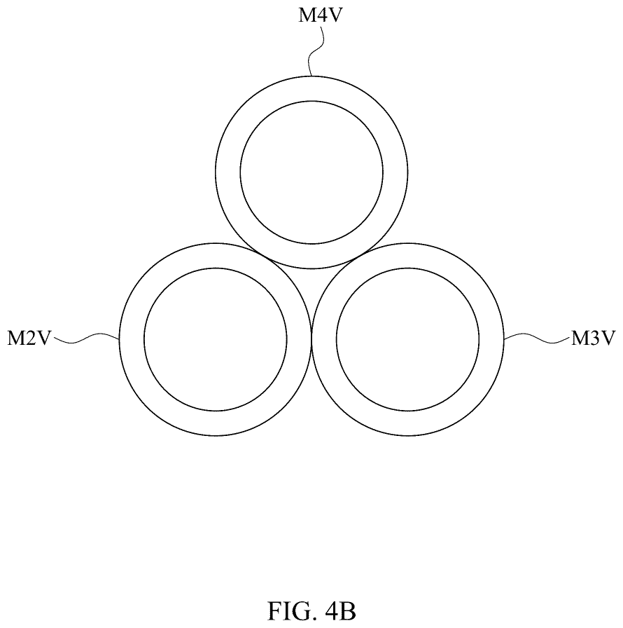

FIG. 4A is a cross-sectional view of a phased array antenna 400, in accordance with some embodiments of the present disclosure. The phased array antenna 400 is similar to the phased array antenna 300 in many aspects, and thus descriptions of similar features are omitted for brevity. A major difference between the phased array antenna 400 and the phased array antenna 300 is that the third dielectric layer D3 of the phased array antenna 400 is patterned to form the trenches R3 (not separately shown) using a photolithography operation in a manner similar to that used in the formation of the recesses R1 or R2. The trenches R3 etched using the photolithography operation may include a sidewall with a more gradual slope. In other words, the trenches R3 etched using the laser drilling operation (see FIG. 2M for example) may include a sidewall that is more vertical than those formed using the photolithography operation.

Moreover, the fourth metallization layer M4 formed in the phased array antenna 400 may include a shape conformal to the patterned third dielectric layer D3. The fourth metallization layer M4 may be formed using deposition, photolithography and etching operations. According to some embodiments, the fourth metallization layer M4 includes titanium and copper and is formed using PVD, e.g., sputtering. According to some other embodiments, the fourth metallization layer M4 includes copper and is formed using an ECD process. According to some embodiments, conductive planes or conductive lines of the fourth metallization layer M4 have a thickness between about 4 μm and about 15 μm. According to some embodiments, conductive vias M4V of the fourth metallization layer M4 have a width greater than about 40 μm, e.g., between about 40 μm and about 70 μm.

FIG. 4B is a top view of conductive vias M2V, M3V and M4V in different metallization layers of an RDL 204 of the phased array antenna 400, in accordance with some embodiments of the present disclosure. The conductive vias M2V, M3V and M4V are non-overlapping from a top-view perspective, which fulfills design rule check requirements. According to some embodiments, the conductive vias M2V, M3V and M4V are arranged immediately adjacent to each other without overlapping from a top-view perspective to reduce a footprint of the RDL 204. According to some embodiments, the conductive vias M2V, M3V and M4V are tangent to each other from a top-view perspective.

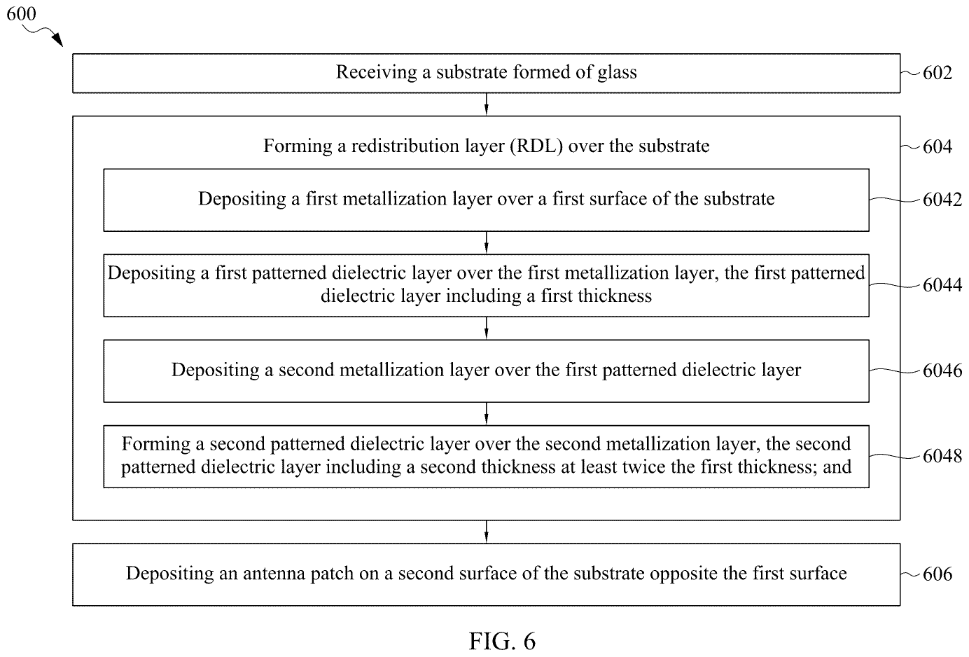

FIG. 6 is a schematic flowchart of a method 600 of forming a phased array antenna, in accordance with some embodiments. It should be understood that additional steps can be provided before, during, and after the steps shown in FIG. 6, and some of the steps described below can be replaced or eliminated, for additional embodiments of the method shown in FIG. 6. An order of the steps may be changed.

In step 602, a substrate formed of glass is received.

In step 604, a redistribution layer (RDL) is formed over the substrate. Details of the formation of the RDL are provided in steps 6042, 6044, 6046 and 6048.

In step 6042, a first metallization layer is deposited over a first surface of the substrate.

In step 6044, a first patterned dielectric layer is formed over the first metallization layer, wherein the first patterned dielectric layer has a first thickness.

In step 6046, a second metallization layer is formed over the first patterned dielectric layer.

In step 6048, a second patterned dielectric layer is formed over the second metallization layer, wherein the second patterned dielectric layer has a second thickness at least twice the first thickness.

In step 606, an antenna patch is formed on a second surface of the substrate opposite the first surface.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an antenna device, the method comprising:
receiving a substrate formed of glass;
forming a redistribution layer (RDL) over the substrate, wherein the forming of the RDL comprises:
depositing a first metallization layer over a first surface of the substrate;
depositing a first patterned dielectric layer over the first metallization layer, wherein the first patterned dielectric layer has a first thickness; and
depositing a second metallization layer over the first patterned dielectric layer; and
forming a second patterned dielectric layer over the second metallization layer,
wherein the second patterned dielectric layer comprises a photoimageable dielectric (PID) material, wherein the second patterned dielectric layer has a second thickness at least twice the first thickness.

2. The method of claim 1, wherein the depositing of the first metallization layer is performed by physical vapor deposition (PVD).

3. The method of claim 1, further comprising depositing a third metallization layer on the second patterned dielectric layer by electrochemical deposition (ECD).

4. The method of claim 3, wherein the depositing of the third metallization layer comprises depositing a conductive via extending through the second patterned dielectric layer.

5. The method of claim 1, further comprising depositing an adhesive layer over the first surface prior to the depositing of the first metallization layer, wherein the adhesive layer comprises a material including silicon nitride, silicon oxide or polyimide.

6. The method of claim 1, further comprising depositing a third patterned dielectric layer over the first surface prior to the depositing of the second patterned dielectric layer, wherein a sum of the first thickness and a thickness of the third patterned dielectric layer is less than the second thickness.

7. The method of claim 6, wherein the sum of the first thickness and the thickness of the third patterned dielectric layer is between about 2 μm and about 20 μm.

8. The method of claim 1, further comprising depositing an antenna patch on a second surface of the substrate opposite the first surface.

9. The method of claim 8, wherein the first metallization layer is configured to define a slit configured to magnetoelectrically couple a radio-frequency signal to the antenna patch through the substrate.

10. The method of claim 1, wherein the forming of the second patterned dielectric layer comprises:
disposing the PID material on the second metallization layer; and
pressing the PID material to generate a substantially flat surface of the second patterned dielectric layer.

11. The method of claim 1, wherein the forming of the second patterned dielectric layer is performed using a vacuum laminator.

12. The method of claim 1, further comprising cutting the substrate into a plurality of substrate units prior to the forming of the second patterned dielectric layer.

13. An antenna device, comprising:
a substrate formed of glass;
a redistribution layer (RDL) arranged on a first surface of the substrate, the RDL comprising:
a first metallization layer over the first surface of the substrate;
a first dielectric layer over the first metallization layer, wherein the first dielectric layer has a first thickness;
a second metallization layer over the first dielectric layer and electrically coupled to the first metallization layer; and
a second dielectric layer over the second metallization layer and the first dielectric layer,
wherein the second dielectric layer comprises a photoimageable dielectric (PID) material, wherein the second dielectric layer has a thickness at least twice the first thickness.

14. The antenna device of claim 13, wherein the first dielectric layer comprises silicon nitride, silicon oxide, polymer, PID, or photosensitive polyimide.

15. The antenna device of claim 13, wherein the first thickness is between about 0.5 μm and about 10 μm.

16. The antenna device of claim 13, wherein a thickness of the RDL, measured from a lower surface of a bottom dielectric layer to an upper planar surface of the second dielectric layer, is between about 15 μm and about 60 μm.

17. The antenna device of claim 13, wherein the first metallization layer comprises a conductive plane configured as a ground plane of the antenna device.

18. The antenna device of claim 13, further comprising:
a radio-frequency (RF) chip over the RDL; and
an antenna patch on a second surface of the substrate opposite the first surface.

19. The antenna device of claim 18, wherein the substrate is free of any conductive elements within a projection area of the antenna patch.

20. The antenna device of claim 18, wherein the RDL further comprises a third metallization layer arranged between the RF chip and the second dielectric layer, wherein the third metallization layer is configured to transmit power and an RF signal between the RDL and the RF chip.
